(19) United States
(12) Patent Application Publication
(10) Pub. No.: US 2006/0288371 A1
(43) Pub. Date: Dec. 21, 2006

(54) Mobile terminal and method for operation

(75) Inventors: Sung Bae Jun, Anyang-si (KR); Yong Uk Lee, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/437,031

(22) Filed: May 19, 2006

(30) Foreign Application Priority Data
Jun. 15, 2005 (KR) 10-2005-0051370

(51) Int. Cl. H04N 5/445; G06F 13/00; G06F 3/00; H04N 7/16

(52) U.S. Cl. 725/52; 725/62; 725/37; 725/53

(57) ABSTRACT

A mobile terminal and an operating method thereof are provided. An operating method includes driving the mobile terminal that supports a multitasking environment, executing a terminal application by driving the mobile terminal and calling a home screen application, and setting an initial screen of the home screen application as a home screen of the mobile terminal after driving the called home screen application.

### CROSS-REFERENCE TO RELATED APPLICATIONS

Pursuant to 35 U.S.C. §119(a), this application claims the benefit of earlier filing date and right of priority to Korean Patent Application No. 10-2005-0051370 filed on Jun. 15, 2005; the contents of which is hereby incorporated by reference herein in its entirety.

### BACKGROUND OF THE INVENTION

1. Field of the Invention

The present invention relates to a mobile terminal and method for operating.

2. Description of the Related Art

A home screen can be modified using a data driven method in a related art mobile terminal. The home screen is an initial screen that is displayed when the mobile terminal is activated. The home screen is configured with hard-coded layout information. Information from data files is displayed according to the layout, and the data files may contain display parameters. Thus, the home screen of the mobile terminal is configurable. In a system, it is possible for a user to change the data for modifying an image of the home screen.

The mobile terminal is a core device for digital convergence. When the initial screen is displayed as the home screen of the mobile terminal, useful and convenient applications can be accessed easily, and data and voice call information can be displayed in the home screen. However, in the related art mobile terminal, the initial screen of the home screen application is not displayed as the home screen. Accordingly, a corresponding application can be executed only by a direct input of a user. Otherwise, the application cannot be executed in the initial screen of the mobile terminal.

Additionally, since a standard platform has not been adapted by the various terminal manufactures, various services and applications are provided and accessed differently by the various manufactures. Consequently, it is difficult to effectively use the terminal resources and to provide reasonably priced solutions.

### SUMMARY OF THE INVENTION

Accordingly, the present invention is directed to a mobile terminal and operating method that substantially obviates one or more problems due to limitations and disadvantages of the related art.

An object of the present invention is to provide a mobile terminal for executing a terminal application and a home screen application simultaneously in a multitasking environment and displaying an initial screen as a home screen.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve these objects and other advantages and in accordance with the purpose of the invention, as embodied and broadly described herein, an operating method of a mobile terminal is provided, the method includes: activating a mobile terminal that supports a multitasking environment; executing a terminal application by activating the mobile terminal and calling a home screen application; and displaying an initial screen of the home screen application as a home screen.

In another aspect of the present invention, an operating method of a mobile terminal supporting a multitasking environment is provided, the method includes: starting a home screen application by executing a terminal application; selecting an initial screen of the home screen application as a home screen of the mobile terminal; and displaying a home screen in a foreground and the terminal application in a background by the home screen application.

In a further another aspect of the present invention, a mobile terminal supporting a multitasking environment is provided, the mobile terminal including: a terminal application module activated by initializing the mobile terminal and starting other applications; a home screen application module initiated by the terminal application module, and selecting an initial screen as a home screen of the mobile terminal by a predetermined parameter file; and a data storage unit storing the parameter file used to define the home screen.

The foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a mobile terminal according to an embodiment of the present invention;

FIG. 2 is a diagram illustrating an example of a home screen using a terminal application and a home screen application of a mobile terminal according to an embodiment of the present invention;

FIG. 3 is a diagram illustrating modifying a home screen when an event occurs using a terminal application and a home screen application of a mobile terminal according to an embodiment of the present invention;

FIG. 4 is another configuration of a home screen using a terminal application and a home screen application of a mobile terminal according to an embodiment of the present invention;

FIG. 5 illustrates a relationship between a terminal application and a home screen application in a mobile terminal according to an embodiment of the present invention;

FIG. 6 illustrates an example of a home screen according to an incoming/outgoing call of a mobile terminal according to an embodiment of the present invention;

FIG. 7 is an example of a home screen using a web page according to an embodiment of the present invention;

FIG. 8 is an example of a home screen using an electric mail (E-mail) according to an embodiment of the present invention;

FIG. 9 is an example of a home screen using home shopping advertisements according to an embodiment of the present invention;

FIG. 10 is a flowchart of a method of providing a home screen in a mobile terminal according to an embodiment of the present invention; and

FIG. 11 is a flowchart of another method of providing a home screen in a mobile terminal according to an embodiment of the present invention.

### DETAILED DESCRIPTION OF THE INVENTION

Reference will now be made in detail to the embodiments of the present invention, examples of which are illustrated in the accompanying drawings. Wherever possible, the same reference numbers will be used throughout the drawings to refer to the same or like parts.

According to the present invention, a mobile terminal (“terminal”) includes a mobile phone, a phone with a camera, a personal digital assistance (PDA), and a multimedia mobile phone. The terminal supports a multitasking environment and can execute several applications simultaneously.

An Application Programming Interface (API) is a language and message format used by an application program to communicate with the operating system (OS), some other control program such as a database management system (DBMS), or a communications protocol. The API is implemented by writing function calls in the program, which provide the linkage to the required subroutine for execution. Thus, one API includes several program modules or routines that already exist or are to be linked to perform operations requested by the function calls. That is, an application can use various functions of the OS through the API.

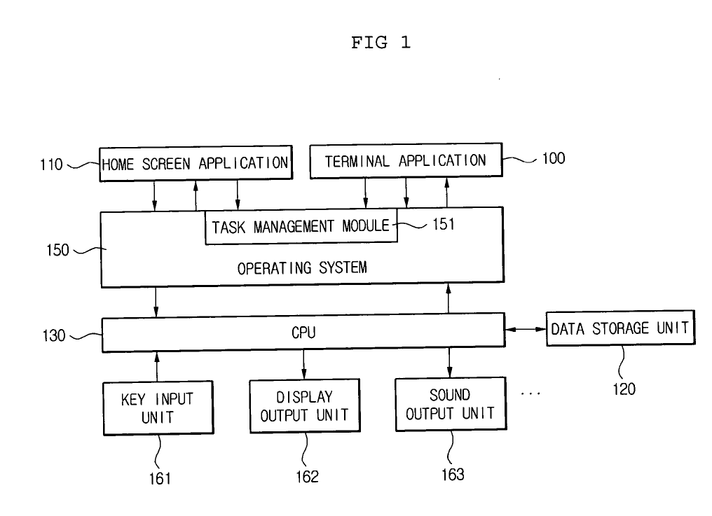

As illustrated in FIG. 1, the terminal includes a plurality of applications such as a terminal application (TA) 100 and a home screen application (HSA) 110, a data storage unit 120, a central processing unit 130 (CPU), an operating system (OS) 150, a key input unit 161, a display output unit 162, and a sound output unit 163.

The terminal application 100 is operated together with the terminal, and an application for basic terminal functions. Additionally, the terminal application 100 can call or initiate other applications.

The functions of the terminal application are handling incoming or outgoing of voice and data, and other events. An application initial screen can be set as a home screen, or the home screen can be set by default.

The home screen application 110 is initiated by a call of the terminal application 100, and forms a background screen together with the terminal application 100. That is, the terminal application 100 and the home screen application 110 are selectively displayed in the foreground and background and then executed according to a system environment or an event occurrence.

The home screen application 110 is called by the terminal application 100, and the initial screen of the home screen application 110 can be set as the home screen of the mobile terminal.

Additionally, the initial screen of the home screen application 110 can be set as the home screen by default using the terminal application 100. The initial screen of the home screen application 110 can be file information that is edited or modified by a user. That is, the home screen is configured by an application driven method.

The OS 150 supports a multitasking environment to execute a plurality of applications, and stores necessary information for a task management of each application.

The CPU 130 is a modem chip processor or a processor including the modem chip processor, and has supporting functions of a call process and a wireless internet.

The key input unit 161 is for providing user input and plays a role in sending an event to the CPU after receiving the event from the user. The display output unit 162 is a display unit for displaying an initial screen, event status information, and video. The sound output unit 163 provides an audio signal. The data storage unit 120 stores programs necessary for executing applications, various user information, and data necessary for a display configuration.

Operations for providing a dynamic home screen are the following.

When a user request is inputted through the key input unit 161, the terminal is operated according to the request. At this point, the terminal application 100 is called by the terminal, and the terminal application 100 calls the home screen application 110. Then, the initial screen of the home screen application 110 is executed as the terminal home screen through the OS 150, the CPU 130, and the display output unit 162. Here, the terminal application 100 can set the initial screen of the home screen application as the home screen by default.

When the initial screen of the home screen application 110 is displayed as the home screen, the user can directly access items and menus displayed on the home screen. Accordingly, useful functions and information provided by the terminal or the carrier can be accessed without inputting additional commands. That is, the home screen includes menu information.

Additionally, the terminal application 100 executes the home screen application 110 in the foreground according to parameters stored in a terminal. Here, the foreground of the home screen application 110 can be embodied as the home screen in the entire display or a portion of the display. Accordingly, the background of the terminal application 100 can be placed on the foreground as a popup or on another area different from the foreground.

Here, the parameters include information about a location (file name) of the home screen application 110. The parameter data can include parameters about a screen position and size, a full screen mode, a data file, and the location information. The position of the screen is an arranged position in the home screen, and the size of the screen is the size of the home screen. The full screen mode includes information about whether the home screen is displayed in full screen mode or not.

The parameter data is stored in the data storage unit 120 configured with nonvolatile memory. The parameter data stored in the data storage unit 120 is designated when the home screen application 110 is installed, and also can be modified or edited by the user or the carriers.

On the other hand, when the home screen application 110 is executed as the home screen, a corresponding event is directly delivered to the terminal application 100 according to the specific event. The terminal application 100 receives the event and executes a user interface (UI) corresponding to the event in the foreground. Additionally, when the event is terminated, the home screen application 110 is redisplayed in the foreground.

Moreover, switching of the foreground and background is necessary between two applications according to a system situation or an input of the user. For example, the terminal application 100 is executed in the foreground according to an incoming call or an outgoing call. At this point, the UI responds to an incoming call or an outgoing call using the UI embedded in the terminal application 100. Additionally, when the request and the execution about the call are completed, the home screen application 110 is automatically restored to the foreground again, and then constitutes the home screen.

Moreover, when another event occurs, the UI corresponding to the event is executed in the foreground after the terminal application 100 receives the event.

Here, the initial screen of the home screen application 110 executed in the background can be set as another screen. The parameter for the background execution is stored in the nonvolatile memory. Additionally, the background parameter can be stored when the home screen application 110 is installed, and also edited and modified by the user or the carriers.

Additionally, the home screen application 110 can be provided at the time of manufacture, by the carriers, or a download request of the user.

Additionally, each terminal can include a plurality of home screen applications and the user can designate each home screen application to be executed.

Here, the parameter data of the home screen application 110 can be carrier information or web information such as a newspaper service, a shopping information service, and an E-mail service. The parameter data includes user data (e.g. user phone number information, name card information, test file information, etc.) stored in the terminal.

Additionally, the home screen application can include a real-time updatable file (e.g. web page) or a real-time playable file for an audio or video player. Accordingly, the web page can be updated and viewed by the user, and also an audio file can be played as soon as the home screen is executed.

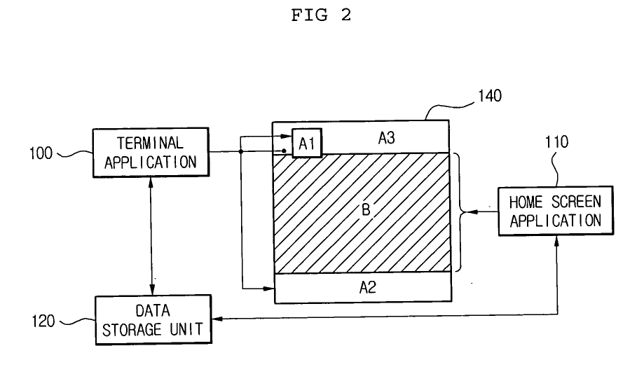

FIGS. 2 to 4 are diagrams illustrating various configuration examples of the home screen using the terminal application 100 and the home screen application 110 of the mobile terminal according to an embodiment of the present invention.

Referring to FIG. 2, in a screen display unit 140, basic display areas A2 and A3, which will be executed later by the terminal application 100, can be executed in a background. Then, the home screen area B is configured by the home screen application 110.

Here, for example, an A2 area displays menu information, and an A3 area displays antenna and battery information. An A1 area in the A3 area displays information about an option item. Here, the basic display area can be set by default.

Moreover, the home screen is a displayed area B (exclusive of the basic display areas A2 and A3), and information to be executed in the area B can be edited and modified by the user.

The display data, which will be displayed in the terminal application 100 and the home screen application 110, is stored in the data storage unit 120. The data storage unit 120 includes volatile or nonvolatile memory.

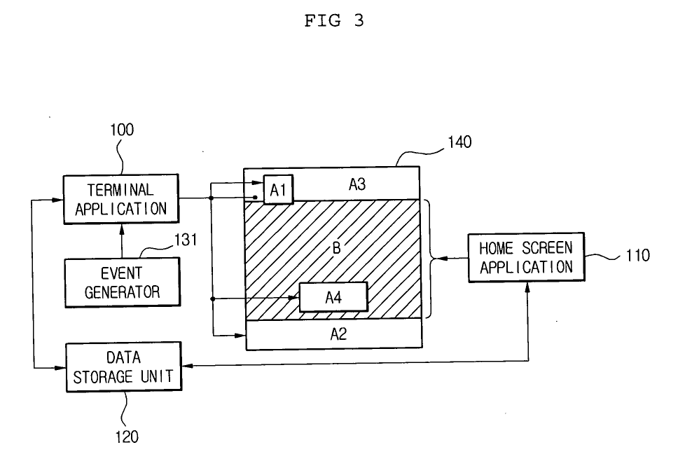

Referring to FIG. 3, the home screen is set by the home screen application 110. Then, when an event occurs by an event generator 131, the terminal application 100 displays the UI corresponding to the event in a predetermined position of the home screen.

At this point, the UI is displayed in the foreground and then the home screen is displayed in the foreground when the event is completed.

Additionally, the basic display area can be different in length and width according to the mobile terminal. Other parameters can be added or existing parameters can be reduced according to the terminal.

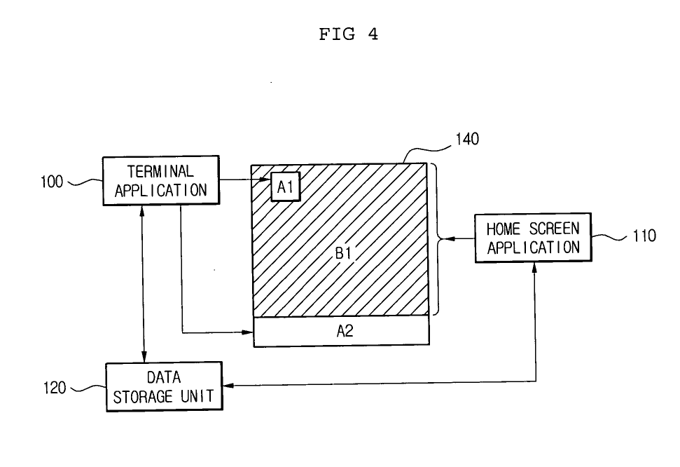

As illustrated in FIG. 4, the home screen is expanded by the terminal application 100, and the initial screen of the home screen application 110 is displayed in an expanded home screen. Additionally, optional information A1 can be displayed in the expanded home screen. Here, the initial screen of the home screen application 110 is executed in the foreground, but information to be executed by the terminal application 100 can be executed as a popup in the foreground.

The home screen of the screen display unit 140, where the initial screen of the home screen application 110 is executed, is a variable area where other data can be replaced and modified. Additionally, the basic display area is a default area where a predetermined terminal interface is displayed. The basic display area can be included in the variable area, and vice versa.

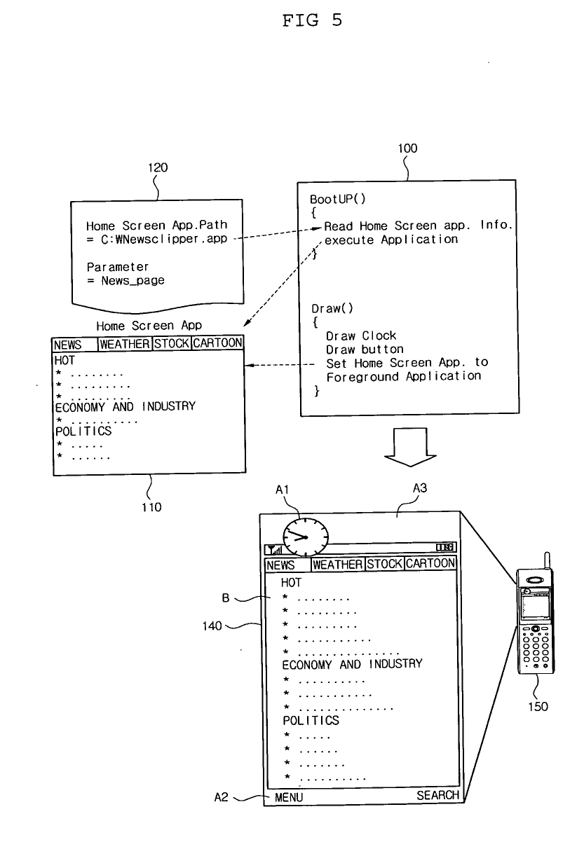

FIG. 5 is a diagram illustrating a news page as the home screen application 110 of the mobile terminal according to an embodiment of the present invention.

When terminal application 100 is executed after the terminal is initialized, the terminal application 100 is guided to the initial screen file path of the home screen application 110 stored in the data storage unit 120. Then, the terminal application 100 reads the path data of the home screen application 110.

At this point, the terminal application 100 sets the basic display parameters (clock or button) together with the home screen application 110 as a foreground application.

For example, when the initial screen of the home screen application 110 is set as a news page, the news page is displayed in a home screen area B of the screen display unit 140, and the basic display information is displayed in other areas A1, A2, and A3.

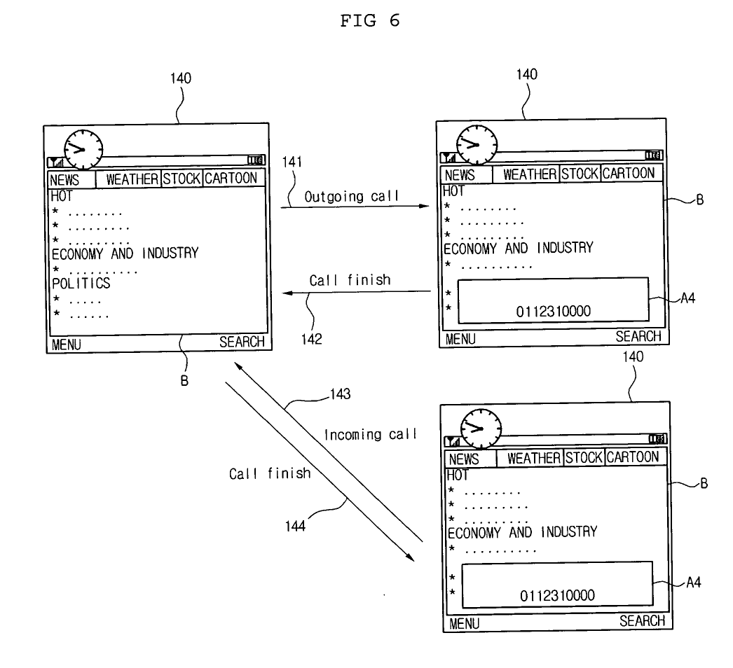

FIG. 6 illustrates a change of the home screen according to an event occurrence of the terminal.

First, the home screen is executed in a foreground by the home screen application 110 in the screen display unit 140. Next, when an outgoing call 141 is generated, information about the outgoing call 141 is displayed in the UI A4 in the foreground and the home screen area B of the home screen application 100 is displayed in the background.

Additionally, when finishing the outgoing call 142, the home screen is redisplayed in the foreground.

When incoming call 143 occurs, information about the incoming call 143 is displayed in the foreground of the home screen. Then, when the incoming call is finished 144, the home screen is redisplayed in the foreground.

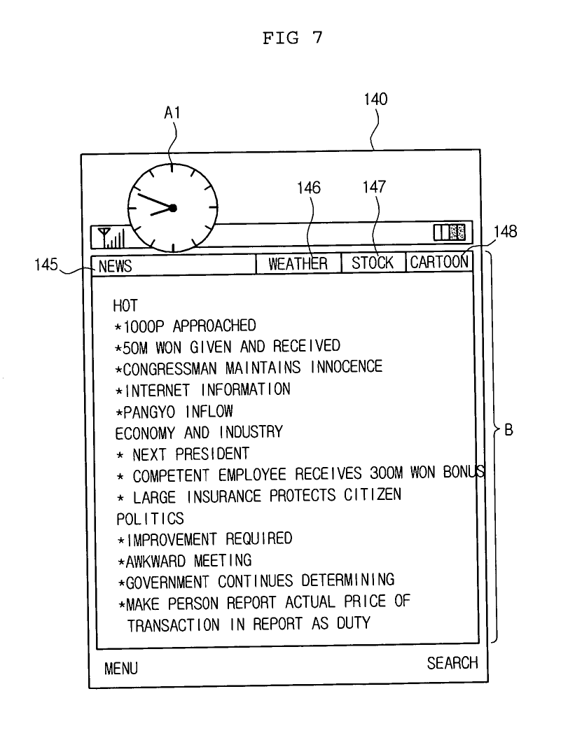

As illustrated in FIG. 7, when the initial screen of the home screen application 110 is executed in the home screen B, a user can access various items provided on the home screen. For example, the user can select a weather item 146, a stock item 147, or a cartoon item 148 using a direction key or other keys (including a touchpad) when news items of the news page are displayed in the home screen. When a specific item is selected among the items, the home screen application 110 executes a corresponding item as a popup. The home screen is operated by connecting with a real-time wireless Internet.

The carriers can provide latest news to the user using a push method to the home screen application. Accordingly, the user may view the latest news without an additional input, and if necessary, more specific news can be searched using a pull method. Moreover the user can update the latest news without additional operations.

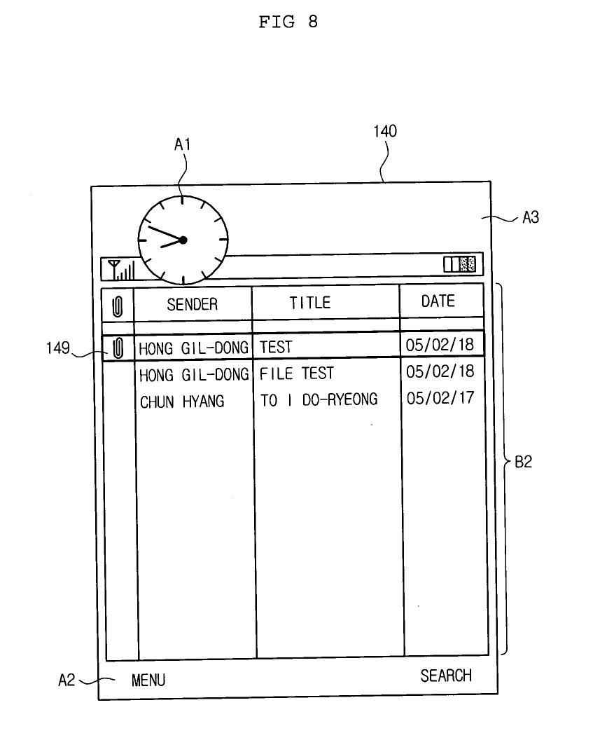

As illustrated in FIG. 8, when an E-mail is displayed in the home screen B, the E-mail information (e.g. sender, title, date, etc.) can be displayed. At this point, when a test title with an attachment file 149 is selected, the corresponding E-mail item is displayed as a popup and then it is possible to confirm and execute the E-mail.

In the home screen application, when the carriers notify the E-mail arrival using a push E-mail method, the user can notice and then download the actual E-mail if necessary.

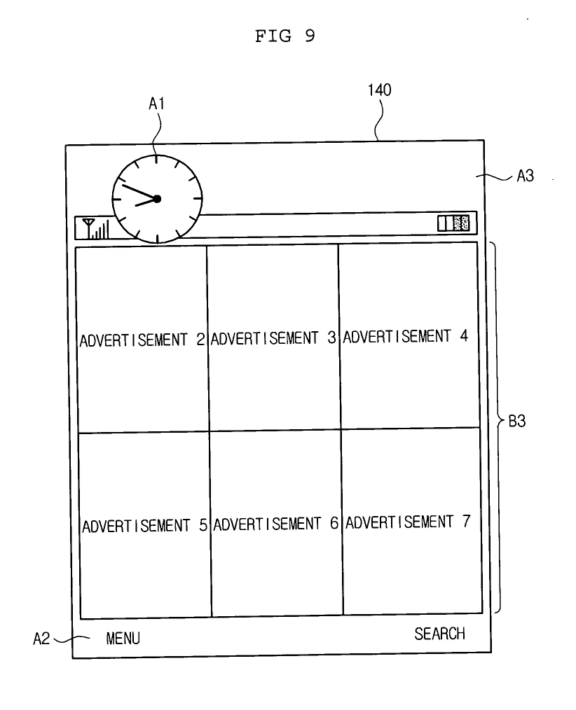

FIG. 9 is a diagram illustrating a configuration example of a home screen using home shopping advertisements according to an embodiment of the present invention. When the user selects each advertising item, the web page of the corresponding item can be executed as a popup. When this shopping information is displayed using a push method, the user can purchase products easily if necessary.

As illustrated in FIGS. 7 to 9, the user can access the information in the home screen of the terminal, and other home screen can be configured in a foreground through the user access. Additionally, when configured in the foreground, the home screen can be displayed in the same size or different size (e.g. full screen mode) of the previous home screen.

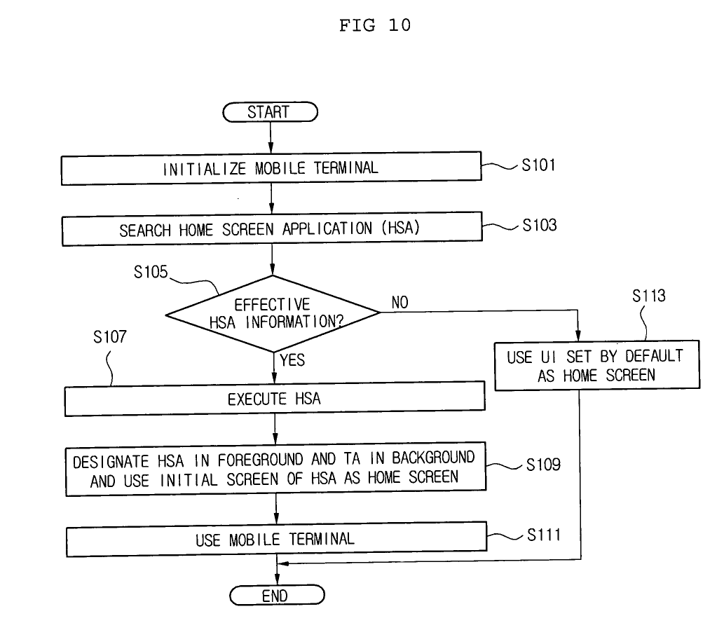

FIG. 10 is a flowchart of a method of providing a home screen in a mobile terminal according to an embodiment of the present invention.

In operation S101, the terminal is initialized according to a user request. The terminal application is executed through various processes. The terminal application examines the system, sets up a terminal environment, and then searches parameter files to constitute and display the home screen.

At this point, the terminal application searches the home screen application in operation S103 and also verifies whether there is information of a home screen application or not in operation S105.

After verification of screen application information, the home screen application is executed in operation S107. At this point, the initial screen of the home screen application is executed and displayed in the foreground, and the UI of the terminal application is designated as a background. Accordingly, the initial screen of the home screen application is used as the home screen in operation S109.

When the home screen is ready, an initial booting of the mobile terminal is completed in operation S111.

After verification of the operation S105, if there is no home screen application, the UI set as default in the terminal application is used as the home screen in operation S113. In another example, the initial screen to be executed as the home screen of the terminal application can be edited or modified by the user.

In other words, the terminal application searches parameter files to constitute the home screen. At this point, when there is no parameter file to be searched or no contents in the parameter file, it is recognized as a file error. Accordingly, a default UI defined in the terminal application is used as the home screen.

However, when the parameter file is detected, the terminal application executes the home screen application according to the information in the parameter file. The home screen application is executed in the foreground, and the terminal application is executed in the background. Accordingly, the initial screen of the home screen application is used as the home screen.

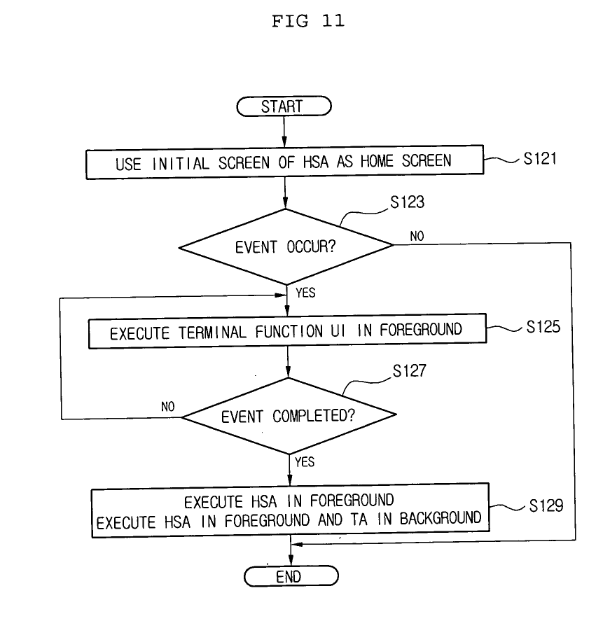

FIG. 11 is a flowchart of another method of providing the home screen in the mobile terminal according to an embodiment of the present invention.

In operation S121, when the initial screen of the home screen application is used as the home screen, an event is detected in operation S123.

When the terminal application recognizes the event, the terminal application executes the event. Moreover, when the home screen application recognized the event, the event is forwarded to the terminal application and then executed.

When the event occurs, the UI corresponding to the event is executed in operation S125. At this point, since an execution of the event is a terminal function, the execution is controlled by the terminal application. When the home screen is executed, the UI corresponding to the event is executed in the foreground again, and thus the home screen and the event screen are overlapped or in a popup state.

Next, after the verification of operation S127, when the event is finished, the home screen application is executed in the foreground and the terminal application 100 is executed in the background in operation S129.

On the other hand, a method of calling the home screen application in the terminal application is described as the following. First, when manufacturing the mobile terminal, the manufacturer designates and compiles the executable home screen application. A user cannot change the home screen application and thus the HSA is very secure to the virus and hacking.

Second, the terminal application can designate and store files having information to execute the home screen application. The file can be stored in the nonvolatile memory. Additionally, the home screen application can be executed according to the information in the corresponding file. Moreover, when the contents of the parameter file are modified, the home screen application can be changed, and thus the home screen application can be executed flexibly.

The mobile terminal provides an environment where a new home screen application can be installed and an application program interface (API) can modify the parameter file and the UI. The carriers or the users can modify the home screen application using the API and the UI can modify the parameter file.

After the modification, the terminal is rebooted (cold booting) to apply the modification of the home screen. When using the event driven method, the modification of the home screen application is notified using the terminal application. Additionally, a warm boot that changes the home screen without the reboot can be executed by delivering the event to the terminal application. The event updates and reflects the information of the home screen.

A dynamic home screen updating method, which utilizes the home screen application of the mobile terminal, can be easily applied in an open-type OS that supports the API standardization. Moreover, the method also can be applied to the mobile terminal environment that provides the API standardization. Especially, when the method is applied to the open-type OS platform, a service is available to the terminals of all carriers that select the same corresponding platform.

According to the present invention, since the home screen of the mobile terminal supporting a multitasking can be set as the initial screen of the home screen application, the requests of the carriers can be more rapidly accommodated. Moreover, the mobile manufacturer can respond to each carrier more easily. The mobile terminal user can access a useful service using the home screen. Additionally, when an independent S/W vendor (ISV) develops a useful service for one carrier, the corresponding service can be applicable to all mobile terminals having same platform provided from various manufacturers.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An operating method of a mobile terminal, the method comprising:
initializing the mobile terminal that supports a multitasking environment;
executing a terminal application by driving the mobile terminal and calling a home screen application; and
setting an initial screen of the home screen application as a home screen of the mobile terminal after executing the called home screen application.

2. The method according to claim 1, wherein the terminal application searches a parameter file to constitute the home screen and executes the home screen application according to information contained in the parameter file.

3. The method according to claim 1, wherein the initial screen of the home screen application is executed in a foreground and the terminal application is executed in a background.

4. The method according to claim 1, wherein a user accesses the mobile terminal through the home screen using the home screen application.

5. The method according to claim 2, wherein the parameter file contains information about the home screen application.

6. The method according to claim 5, wherein the information about the home screen application is information about a file location of the corresponding home screen application.

7. The method according to claim 5, wherein the information about the home screen application includes at least one of a position and a size of a screen, whether full-screen mode is executed or not, and data file information used in the home screen application.

8. The method according to claim 1, wherein the home screen application is modified by a user and a communication carrier.

9. The method according to claim 2, wherein the parameter file includes at least one of user data stored in the mobile terminal, data containing a web page downloaded through a network, real-time updating file data, and real-time playing file data.

10. The method according to claim 1, wherein a user interface corresponding to an event is executed in the foreground when the event occurs and the home screen is restored to an original state when the event is completed.

11. The method according to claim 10, wherein the event includes one of an incoming call, an outgoing call, and a data call.

12. The method according to claim 1, wherein the terminal application sets the initial screen of the home screen application as the home screen of the mobile terminal by default.

13. An operating method of a mobile terminal supporting a multitasking environment, the method comprising:
calling a home screen application by executing a terminal application;
setting an initial screen of the home screen application as a home screen of the mobile terminal after executing the home screen application; and
displaying a home screen in a foreground and the terminal application in a background by the home screen application.

14. The method according to claim 13, wherein the terminal application executes a user interface about a call event in the foreground and the home screen application is executed in the background when the call event of the mobile terminal occurs.

15. The method according to claim 13, wherein the terminal application is switched to the foreground or the background with respect to the home screen application and executed according to a call event occurrence or termination.

16. The method according to claim 13, wherein information about the home screen application is modified and edited.

17. A mobile terminal supporting a multitasking environment, the mobile terminal comprising:
a terminal application module executed by the mobile terminal and calling other applications;
a home screen application module executed by the call of the terminal application module, and setting an initial screen as a home screen of the mobile terminal by a predetermined parameter file; and
a data storage unit storing the parameter file used to constitute the home screen.

18. The mobile terminal according to claim 17, wherein the home screen application module includes at least one home screen application.

19. The mobile terminal according to claim 17, wherein the home screen is switched to a foreground or a background by the terminal application module and the home screen application module according to a call event occurrence or an event termination.

20. The mobile terminal according to claim 17, wherein the parameter file includes at least one of user data stored in the mobile terminal, data containing a web page downloaded through an internet, real-time updating file data, and real-time playing file data.
